(19) United States
(12) Patent Application Publication
(10) Pub. No.: US 2022/0314547 A1
(43) Pub. Date: Oct. 6, 2022

(54) SCALING FACTOR

(71) Applicant: HEWLETT-PACKARD DEVELOPMENT COMPANY, L.P., Spring, TX (US)

(72) Inventors: Sergio Gonzalez Martin, Sant Cugat del Valles (ES); Manuel Freire Garcia, Sant Cugat del Valles (ES); Victor Diego Gutierrez, Sant Cugat del Valles (ES)

(21) Appl. No.: 17/633,607

(22) PCT Filed: Oct. 25, 2019
(86) PCT No.: PCT/US2019/058123

§ 371 Date: Feb. 8, 2022

(51) Int. Cl. B29C 64/386; B33Y 50/00; G05B 19/4099

(52) U.S. Cl. CPC B29C 64/386; B33Y 50/00; G05B 19/4099; G05B 2219/35134

(57) ABSTRACT

Described is an apparatus, a method and a 3D printer to: based on a first representation representing a 3D object to be printed using a build material, the object comprising a body having a surface area and a volume, determine a parameter representing a relationship between the surface area and the volume of the body; determine a scaling factor using the determined parameter; and generate a second representation representing the 3D object in which the 3D object is scaled according to the scaling factor.

### BACKGROUND

A 3D printer may print 3D objects using a build material. The 3D printer may deposit the build material onto a print bed during printing. After printing, the geometry of the printed 3D object may change.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a simplified schematic view of an apparatus for performing certain examples;

FIG. 2 is a first flow diagram illustrating a first example method relating to a 3D object to be printed using a build material;

FIG. 3 is a simplified schematic perspective view of an example 3D object;

FIG. 4 is a second flow diagram illustrating a second example method relating to a 3D object to be printed using a build material;

FIG. 5 is a sketch of an example graph indicating illustrative data relating to a set of 3D objects; and

FIG. 6 is a simplified schematic view of an example 3D printer.

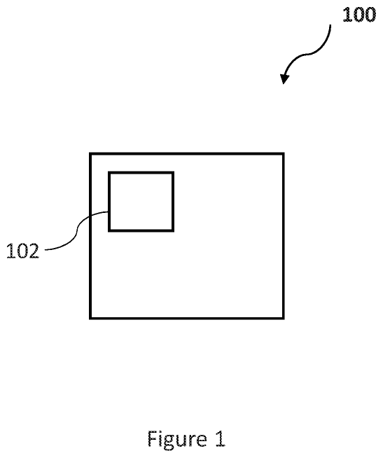

FIG. 1 is a simplified schematic view of an apparatus 100. The apparatus 100 comprises a processor 102 to, based on a first representation representing a 3D object to be printed using a build material, the object comprising a body having a surface area and a volume, determine a parameter representing a relationship between the surface area and the volume of the body. Further, the processor 102 is to determine a scaling factor using the determined parameter, and generate a second representation representing the 3D object in which the 3D object is scaled according to the scaling factor.

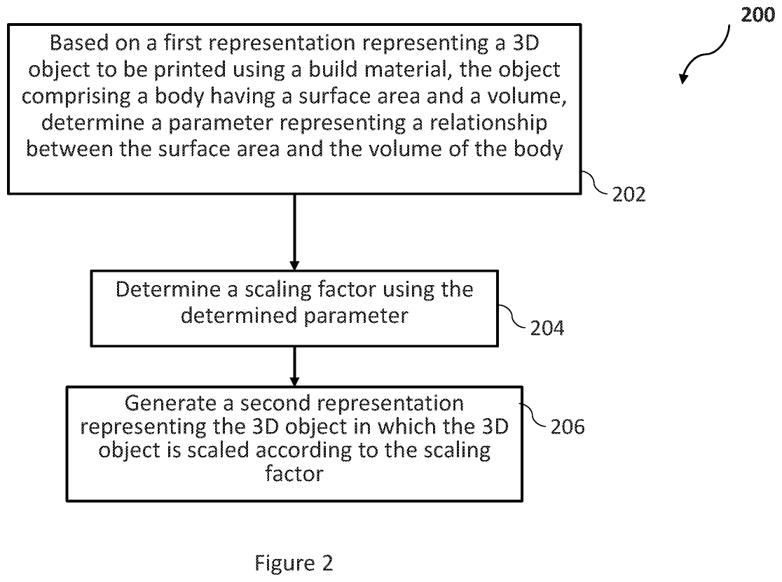

FIG. 2 is a flow diagram of a first example method 200. The first method 200 comprises the following processing blocks. At block 202, based on a first representation representing a 3D object to be printed using a build material, the object comprising a body having a surface area and a volume, a parameter representing a relationship between the surface area and the volume of the body is determined. At block 204, a scaling factor using the determined parameter is determined. At block 206, a second representation of the 3D object is generated in which the 3D object is scaled according to the scaling factor.

The first method 200 may, for example, be performed by the processor 102. The following description is in the context of the processor 102 performing the process blocks of the first method 200.

Accordingly, the apparatus 100 is for scaling a 3D object to be printed using a build material. For example, the 3D object may be printed using a 3D printer in an additive manufacture process. The build material may also be referred to as an additive manufacture material. Examples of build materials include polyamide (also referred to as nylon—examples include polyamide 11 (PA-11), polyamide 12 (PAI12), etc.), polystyrenes, thermoplastic elastomers, polyaryletherketones, etc. In some examples, the build material may be in the form of a powder. In some examples, the additive manufacture process may be one in which the build material is formed in layers, for example, on a print bed (e.g. a powder-based thermal fusing process). The build material may be preheated. In some examples, portions of each layer may be selectively solidified through the application of heat. For example, portions of each layer may be caused to heat up, melt, coalesce and then solidify upon cooling. In some examples, a point heat source such as a laser may be used. In some examples, a heat absorbing fusing agent may be used and heat may be uniformly applied to the layers. The 3D object may shrink upon cooling, for example. Examples of additive manufacture processes include selective laser sintering, high speed sintering processes, etc.

The first representation may comprise a mesh representation of the 3D object. For example, the mesh representation may be a triangle mesh representation. For example, the mesh representation may be a mesh of triangles which represents the surface of the body of the 3D object. In some examples, the mesh representation may be a mesh comprising a shape other than triangles. For example, the mesh representation may be a quadrilateral mesh representation, a hexagonal mesh representation, and the like. It will be understood that the triangle mesh representation, for example, may represent the surface of the body of the 3D object by specifying positions of vertices of the triangles in the mesh, the orientations of the normal vector of the triangles in the mesh, and the like.

The first representation may also comprise other information to define the 3D object. In some examples, the first representation may be in the form of a 3D manufacturing format (3MF) file which contains the triangle mesh representation of the 3D object and an associated affine 3D transformation matrix. The affine 3D transformation matrix may apply one or more affine transformations to the 3D object (e.g. translation, rotation, scaling, etc.). For example, the 3D object to be printed may be defined by the mesh representation and an associated affine 3D transformation matrix.

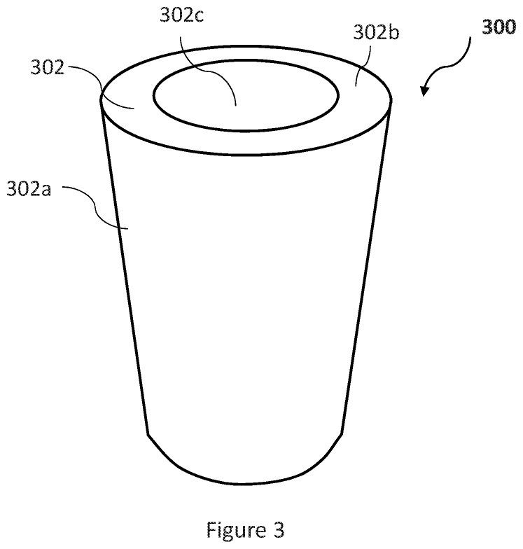

FIG. 3 is a simplified schematic perspective view of an example 3D object 300. The 3D object 300 comprises a body 302. In this example, the body 302 is a cylinder. The surface area of the body 302, as referred to herein, is the total surface area of the body 302 taking account of all the surfaces of the body 302. For example, the surface area of the body 302 includes the areas of the external surface 302a, the top surface 302b, the bottom surface (the surface at the bottom which is equivalent to the top surface 302b—not shown in FIG. 2) and the internal surface 302c.

The volume of the body 302, as referred to herein, is the volume enclosed by all the surfaces of the body 302. In other words, the volume of the body 302 may be thought of as the volume of e.g. build material which forms the body 302. As described, the processor 102 is to determine a parameter representing a relationship between the surface area and the volume of the body 302 based on the first representation. The parameter may also be referred to as a geometry value. The following examples are in the context of the first representation comprising a triangle mesh representation of the body 302.

At block 302, the processor 102 may determine the surface area of the body 302 using the triangle mesh representation and the associated affine 3D transformation matrix. For example, the surface of the 3D object 300 as defined by the triangle mesh representation and any affine transformation specified in the 3D affine transformation matrix (e.g. a scaling in size—which may affect the total surface area) may be taken into account to determine the surface area of the 3D object 300 to be printed. The processor 102 may also determine the volume of the body 302 using the triangle mesh representation and the associated affine 3D transformation matrix. The processor 102 may then determine the relationship using the determined surface area and volume.

In some examples, the relationship between the surface area and the volume of the body 302 may indicate a ratio of the surface area of the body 302 to the volume of the body 302. In other examples, the relationship may be a different mathematical function (e.g. a polynomial function, etc.) of the surface area and the volume. The following description is in the context of the relationship being the described ratio.

The parameter may represent the ratio by the parameter being a numerical value corresponding to the ratio directly, for example (in other words, the parameter may directly be the described ratio). In other examples, the parameter may be a function of the ratio (e.g. the parameter may be proportional to the ratio and include a constant of proportionality). The mathematical function used to define the relationship and/or the parameter may depend on, for example, which geometrical effect is being taken into account to determine the described scaling factor.

For example, where the ratio of surface area to volume of the body 302 is used, the ratio, and consequently, the parameter, may be thought of as relating to the hollowness of the 3D object 300. For example, the hollowness of the 3D object 300 may be thought to characterize the amount of build material making up the 3D object 300 versus the amount of space not taken up by the body 302 of the 3D object 300. The described ratio may be thought to relate to the hollowness of 3D objects of any shape. In the following examples, the parameter is the described ratio of the surface area to volume of the body 302.

As described, at block 204 of the first method 200, a scaling factor using the determined parameter is determined. The scaling factor may also be referred to as a size compensation. The scaling factor may be determined using an object hollowness model, for example. The object hollowness model may provide a scaling factor for the 3D object 300 given the parameter representing the ratio. A specific example of the object hollowness model is described in the following.

In this example, the object hollowness model comprises formulas (1), (2) and (3) as shown in the following:

a1×P×x+k1 (1)

a2×P×x+k2 (2)

a3×P×x+k3 (3)

In formulas (1), (2) and (3), a1, k1, a2, k2, a3, k3 and x are constants, and P is the parameter representing the ratio. In this example, inputting the parameter P into formula (1) yields an amount of shrinkage expected to take place in spatial dimension 1, inputting the parameter P into formula (2) yields an amount of shrinkage expected to take place in spatial dimension 2, and inputting the parameter P into formula (3) yields an amount of shrinkage expected to take place in spatial dimension 3. After printing, the 3D object 300 may experience shrinking. In this example, formulas (1), (2) and (3) provide an indication of how much shrinkage may be expected in each spatial dimension depending upon the ratio (in other words, a measure of the hollowness of the 3D object 300). The scaling factor may accordingly be determined in order that the 3D object 300, after printing, has desired spatial dimensions. For example, the scaling factor may indicate an increased size of the 3D object 300 for printing such that, after printing, the 3D object 300 shrinks to the desired size. The desired size may be the size indicated by the original triangle mesh representation and the associated 3D affine transformation matrix, for example.

In some examples, the scaling factor may comprise a compensation factor for each of the spatial dimensions. For example, a compensation factor may be determined for dimension 1 taking into account the expected shrinkage in dimension 1 (determined using formula (1)). A compensation factor may be determined for dimension 2 taking into account the expected shrinkage in dimension 2 (determined using formula (2)). A compensation factor may be determined for dimension 3 taking into account the expected shrinkage in dimension 3 (determined using formula (3)).

Different build materials may have different behavior. Accordingly, the expected shrinkage related to the ratio may be different depending upon the build material used. For example, certain build materials (e.g. PA-12) may not exhibit a strong dependence on the ratio when it comes to shrinkage. For example, certain build material (e.g. PA-11) may exhibit a relatively strong dependence on the ratio when it comes to shrinkage. Different object hollowness models (e.g. comprising formulas different to formulas (1) to (3)) may be used depending upon the build material. For example, as part of block 204, the processor 102 may select the hollowness model according to the build material.

The amount of expected shrinkage may depend not just on the build material used, but also on the printing profile used by the 3D printer to print the 3D object 300. The printing profile may comprise certain parameters for printing such as values relating to print speed, fill density, retraction, shell thickness, layer height, etc. Accordingly, alternatively or in addition to selecting the object hollowness model based on the build material, the processor 102 may select the hollowness model according to a printing profile.

For example, the different object hollowness models may differ from formulas (1) to (3) in the values of one or more of the constants described above. The formulas (1) to (3) are first order polynomial expressions. Alternatively, or in addition, the different hollowness models may differ from formulas (1) to (3) in that they may not be first order polynomials. For example, one or more of the formulas may be second order polynomial, third order polynomials, or other mathematical functions.

As previously described, at block 206, the processor 102 may generate a second representation representing the 3D object 300 in which the 3D object 300 is scaled according to the scaling factor. The second representation may be a representation that can be used by the 3D printer to print the 3D object 300 without further conversion into another representation. The second representation may be a voxel representation of the 3D object 300, for example. It will be understood that in a voxel representation, values may be assigned to voxels (each of which represent a 3D volume in space) in order to define the 3D object 300. For example, the voxel representation may specify what build material to deposit/how to deposit build material at each voxel location of a print bed on which build material is deposited by a 3D printer to print 3D objects. The following description is in the context of the second representation being a voxel representation of the 3D object 300.

In this example, the voxel representation represents the 3D object 300 scaled according to the scaling factor. The scaling factor may be applied to the whole of the 3D object 300, for example. This means that the voxel representation represents, for example, a larger sized version of the 3D object 300 such that the 3D object 300 shrinks to the substantially the desired size after printing.

In some examples, the scaling factor may be incorporated in the first representation, and the voxel representation may be determined using the first representation such that the 3D object 300 in the voxel representation is scaled according to the scaling factor.

Once the scaling factor has been determined at block 204 of the first method 200, the scaling factor may be incorporated into the affine 3D transformation matrix. In this manner, the 3D object 300 may be scaled according to the scaling factor in the first representation. For example, if the 3D object 300 is visualized using the 3MF file where the scaling factor has been incorporated into the affine 3D transformation matrix, the visualized 3D object 300 has a size taking account of the scaling factor. In this example, the voxel representation may be generated from the relevant data in the 3MF file where the scaling factor has been incorporated into the affine 3D transformation matrix so that the 3D object 300 in the voxel representation is scaled according to the scaling factor.

In some examples, the first representation may not represent merely a single 3D object such as the 3D object 300 of FIG. 3, but may represent a plurality of 3D objects. For example, when the first representation is in the form of a 3MF file, as described, the 3MF file may represent a plurality of 3D objects. For example, the 3MF file may comprise a plurality of triangle mesh representations and associated affine 3D matrices. The 3MF file may therefore be used to specify a print job comprising a plurality of 3D objects to be printed.

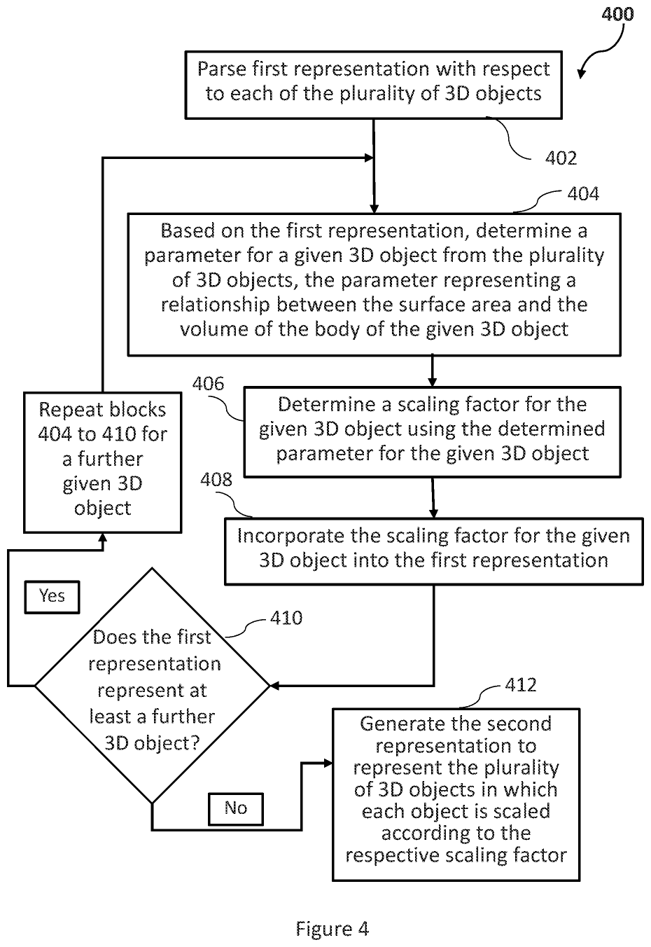

FIG. 4 is a flow diagram illustrating a second example method 400. The second example method 400 is a more specific example of the first method 200 being performed in the context of the first representation representing a plurality of 3D objects. The second method 400 comprises generating the second representation to represent the plurality of 3D objects in which each of the plurality of 3D objects is scaled according to a respective scaling factor. The second method 400 may be performed by the processor 102 of the apparatus 100.

At block 402, the first representation is parsed with respect to each of the plurality of the 3D objects represented by the first representation. For example, the processor 102 parses the 3MF file in order to extract the triangle mesh representation and the associated affine 3D transformation matrix for each of the plurality of 3D objects. In this manner, the processor may individually process the data relating to each of the 3D objects.

At block 404, a parameter for a given 3D object from the plurality of 3D objects is determined based on the first representation, the parameter representing a relationship between the surface area and the volume of the body of the given 3D object. Block 404 corresponds to block 202 of the first method 200. The parameter may therefore be as previously described and may be determined as previously described. The following description is in the context of the parameter being the described ratio. At block 406, a scaling factor for the given 3D object is determined using the respective ratio. Block 406 corresponds to block 204 previously described. Therefore, the scaling factor for the given 3D object may be determined as previously described.

At block 408, the scaling factor for the given 3D object is incorporated into the first representation. For example, the scaling factor may be incorporated into the affine 3D transformation matrix for the given 3D object in the 3MF file, such that when the 3MF file is visualized, the given 3D object has a size taking account of the respective scaling factor.

At block 410, it is determined whether or not the first representation represents further 3D objects. If the first representation represents at least a further 3D object (e.g. if there is a triangle mesh representation and an associate affine 3D transformation matrix in the 3MF file for a further 3D object), then the second method 400 proceeds along the yes branch shown in FIG. 4 and blocks 404 to 410 are repeated for a further given 3D object of the plurality of 3D object. Otherwise, in other words if the result of the determination of block 410 is no, the process proceeds to block 412. At block 412, the second representation (e.g. the described voxel representation) is generated to represent the plurality of 3D objects in which each object is scaled according to the respective scaling factor.

In this manner, for the case of a plurality of 3D objects, a respective scaling factor for each 3D object is determined. The relevant blocks of the second method 400 are repeated in order to perform the method with respect to all the 3D objects in e.g. the 3MF file. The respective factors are applied and the second method 400 yield e.g. a voxel representation in which all the 3D objects have been scaled to account for the shrinkage expected to occur after printing. Accordingly, when the plurality of 3D objects are printed, their shrinkage which depends upon the ratio is compensated for.

When the relevant blocks of the second method 400 are being performed for a given 3D object, the object hollowness model may be chosen in accordance with the build material to be used to print that given 3D object and/or the printing profile to be used to print that given 3D object (as specified by the 3MF file).

As previously described, the scaling factor may be determined using an object hollowness model. The object hollowness model may be determined as part of the first method 200 and/or the second method 400. For example, the processor 102 may determine the object hollowness model. In other examples, the object hollowness model may be determined by an apparatus other than the apparatus 100. For example, the object hollowness model may be determined prior to a block of the first and second methods 200 and 400 at which a scaling factor is determined. Once the object hollowness model is determined, it may be stored e.g. in a computer readable memory for use in performing the described methods.

The object hollowness model may be determined from data indicating shrinkage with respect to the relationship between the surface area and the volume of the bodies of a set of 3D objects. For example, the shrinkage in each of the spatial dimensions may be measured for a set of 3D objects printed in a 3D printing process (e.g. using a 3D printer) whose bodies have different surface area to volume relationships.

Determining the object hollowness model may comprise, for each spatial dimension, determining a formula to represent the relationship between shrinkage and the relationship between the surface area and the volume of the bodies of the plurality of 3D object. Returning to the examples in which the parameter is the ratio, the data for each dimension may be in the form of shrinkage (in the dimension in question) versus the ratio.

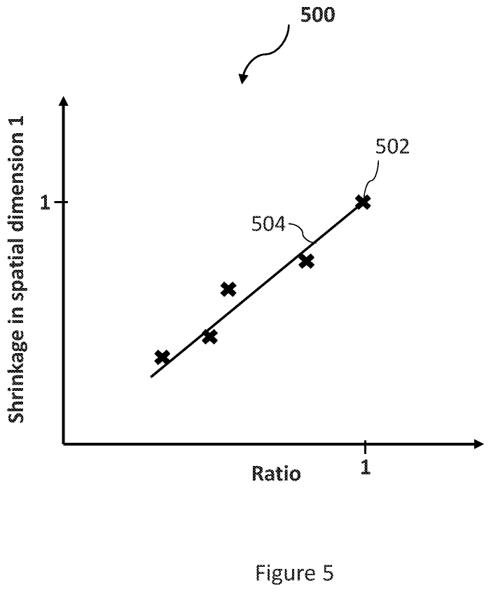

FIG. 5 is a sketch of an example graph 500 illustrating shrinkage versus ratio data in spatial dimension 1 (e.g. the x spatial dimension). In this example, the vertical axis represents shrinkage as compared to intended size in spatial dimension 1. For example, a value of 1 on the vertical axis indicates no shrinkage, whereas a value of 0.99 indicates shrinkage in the spatial dimension 1 to 99% of the indented size. The horizontal axis represents the ratio. In the sketch of FIG. 5, the value 1 on each of the axes is shown.

The graph 500 shows a set of data points corresponding to the set of 3D objects whose data is used to determine the object hollowness model. It should be noted that the data points shown are merely sketched examples. In examples of the object hollowness model being determined, the data may comprise a different number of data points (e.g. a greater number) and the distribution of data points may not be the same as that shown in the sketch. The sketch is merely for illustrative purposes.

In this example, the set of 3D objects includes a hollow pyramid. The data point for the hollow pyramid is indicated by numeral 502, has a ratio of 1 and a shrinkage value on the vertical axis of 1. In this example, the 3D printer used to print the set of 3D objects is calibrated such that the hollow pyramid does not shrink after printing. The object hollowness model being determined in this example may therefore also be suitable for use in relation to another 3D printer calibrated in the same manner. In order to obtain the formula for spatial dimension 1, the data may be fit using an appropriate mathematical function. In the example of FIG. 5, a straight line of best fit 504 is fit to the data. Using the fit, values of the constants a1 and k1 of previously described formula (1) may be determined, for example. In this example, the value of constant x is the ratio of the volume to the surface area of the hollow pyramid (in order words, the inverse of the surface area to volume ratio of the hollow pyramid). It will be understood that a straight line fit would yield a first order polynomial formula like formula (1).

This process may be repeated in order to determine formulas (e.g. formulas (2) and (3)) for spatial dimensions 2 and 3. For example, data for the set of 3D objects indicating shrinkage in the dimension in question versus the ratio may be fit in order to determine the parameters associated with formula for the dimension in question (e.g. for formulas (2) and (3)). As previously discussed, the described formulas may not be first order polynomials. This may be the case where, for example, the best fit for the data is not a first order polynomial but a different mathematical function.

Object hollowness models may be determined for a plurality of build materials to be used to print 3D objects scaled in accordance with the described methods. Furthermore, object hollowness models may be determined for a plurality of printing profiles that may be used to print 3D objects scaled in accordance with the described methods. For example, object hollowness models may be determined for various different combinations of build materials and printing profiles. In this manner, the described methods may be used to scale 3D objects prior to printing for various different combinations of build materials and printing profiles.

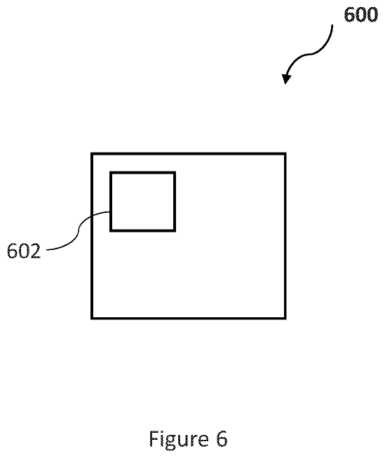

FIG. 6 is a simplified schematic view of a 3D printer 600. The 3D printer 600 comprises a processor 602 to, based on a first representation representing a 3D object to be printed using an additive manufacture material, the object comprising a body having a surface area and a volume, determine a geometry value representing a relationship between the surface area and the volume of the body, determine a size compensation using the determined geometry value and generate a second representation representing the 3D object in which the 3D object is scaled according to the size compensation. The processor 602 may perform any of the described methods.

In some examples, the processor 602 may perform all the described methods including determining various object hollowness models. In some examples, the various hollowness models may be determined remotely from the 3D printer 600 and then stored in a computer readable memory provided in the 3D printer 600.

For example, the 3D printer 600 may receive a 3MF file as part of a print job request to print one or more 3D objects. The processor 602 may generate the second representation (e.g. the voxel representation) in which the one or more 3D objects are scaled in order to compensate for expected shrinkage due to the respective ratios of surface area to volume of the bodies of the one or more 3D objects.

The described methods allow a size compensation to be implemented in the context of 3D printing to account for expected shrinkage which depends upon the ratio (object hollowness) of a 3D object to be printed. Furthermore, the described scaling factor is determined in a manner depending upon the surface area and the volume of the body of the 3D object in question. It will be understood that these physical parameters vary (and their ratio varies) as the 3D object in question is scaled in size. Accordingly, the described methods also compensate, at least partly, for sizing issues which relate to the overall scale at which the 3D object in question is to be printed.

The described methods may be used in combination with other compensation schemes in which, for example, scaling factors are applied depending on the print bed position at which build material is to be deposited, various offsets are applied, etc. Therefore, the described methods may be used to compensate for the object hollowness dependent shrinkage in combination with other methods which compensate for other factors.

The described methods may fit into the current manner in which print jobs are submitted for 3D printing (e.g. via a web service). This is because the described methods enable size compensation relating to object hollowness without fundamental changes to current process flows.

The described methods enable fine tuning depending upon the build material being used and the printing profile being used. This is because, as discussed, object hollowness models for various different combinations of build materials and/or printing profiles may be used.

The described methods enable size compensation relating to object hollowness (defined herein as the ratio of surface area to volume of the body of the 3D object in question) for any 3D object which is to be printed (in other words, any print job sent to e.g. the 3D printer 600). This is because the first representation is processed as described in order to determine how to compensate the size of the 3D objects to be printed. Accordingly, compensation is enabled without calibration by additional instances of the specific 3D objects in question being printed.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An apparatus comprising a processor to:
based on a first representation representing a 3D object to be printed using a build material, the object comprising a body having a surface area and a volume, determine a parameter representing a relationship between the surface area and the volume of the body;
determine a scaling factor using the determined parameter; and
generate a second representation representing the 3D object in which the 3D object is scaled according to the scaling factor.

2. The apparatus according to claim 1, wherein the first representation represents a plurality of 3D objects, and the processor is to generate the second representation to represent the plurality of 3D objects in which each of the plurality of 3D objects is scaled according to a respective scaling factor.

3. The apparatus according to claim 1, wherein the first representation comprises a mesh representation of the 3D object.

4. The apparatus according to claim 1, wherein the second representation is a voxel representation of the 3D object.

5. The apparatus according to claim 4, wherein the scaling factor is incorporated in the first representation, and the voxel representation is determined using the first representation such that the 3D object in the second representation is scaled according to the scaling factor.

6. The apparatus according to claim 1, wherein the relationship between the surface area and the volume of the body indicates a ratio of the surface area of the body to the volume of the body.

7. The apparatus according to claim 1, wherein the scaling factor is determined using an object hollowness model.

8. The apparatus according to claim 7, wherein the processor is to select the hollowness model according to the build material and/or a printing profile.

9. The apparatus according to claim 7, wherein the scaling factor comprises a compensation factor for each of the spatial dimensions.

10. A method comprising:
(i) based on a first representation of a 3D object to be printed using a build material, the object comprising a body having a surface area and a volume, determining a parameter representing a relationship between the surface area and the volume of the body;
(ii) determining a scaling factor using the determined parameter; and
(iii) generating a second representation of the 3D object, the second representation being scaled according to the scaling factor.

11. The method according to claim 10, wherein the first representation represents a plurality of 3D objects, and the method comprises generating the second representation to represent the plurality of 3D objects in which each of the plurality of 3D objects is scaled according to a respective scaling factor.

12. The method according to claim 11, comprising:
(a) parsing the first representation with respect to each of the plurality of 3D objects;
(b) performing (i) and (ii) for a given 3D object of the plurality of 3D objects;
(c) incorporating the scaling factor for the given 3D object into the first representation;
(d) determining whether or not the first representation represents at least a further 3D object, and if the first representation represents at least a further 3D object, repeat (a) to (d) for a further given 3D object of the plurality of 3D objects, otherwise proceed to (e); and
(e) generate the second representation.

13. The method according to claim 10, comprising determining the scaling factor using an object hollowness model.

14. The method according to claim 13, comprising determining the object hollowness model from data indicating shrinkage with respect to the relationship between the surface area and the volume of the bodies of a plurality of 3D objects, wherein determining the object hollowness model comprises, for each spatial dimension:
determining a formula to represent the relationship between shrinkage and the relationship between the surface area and the volume of the bodies of a set of 3D objects.

15. A 3D printer comprising:
a processor to:
based on a first representation of a 3D object to be printed using an additive manufacture material, the object comprising a body having a surface area and a volume, determine a geometry value representing a relationship between the surface area and the volume of the body;
determine a size compensation using the determined geometry value; and
generate a second representation of the 3D object, the second representation being scaled according to the size compensation.
